(19) United States
(12) Patent Application Publication
(10) Pub. No.: US 2026/0074604 A1
(43) Pub. Date: Mar. 12, 2026

(54) Non-circulating-current phase-shift control method for dual active bridge converter

(71) Applicant: Shandong University, Jinan (CN)

(72) Inventors: Hao TIAN, Jinan (CN); Pingchuan LI, Jinan (CN); Feng GAO, Jinan (CN); Tao XU, Jinan (CN); Jingyang FANG, Jinan (CN)

(73) Assignee: Shandong University, Jinan (CN)

(21) Appl. No.: 19/393,531

(22) Filed: Nov. 18, 2025

(30) Foreign Application Priority Data
Feb. 8, 2025 (CN) 202510141430.3

(51) Int. Cl. H02M 1/00; H02M 3/335

(52) U.S. Cl. CPC H02M 1/0043; H02M 1/0058; H02M 3/33584

(57) ABSTRACT

The present invention relates to a non-circulating-current phase-shift control method and system for a dual-active-bridge (DAB) converter. This method addresses the issue of circulating power arising from voltage mismatch between the primary and secondary sides of the DAB converter, which otherwise results in increased current stress, higher power losses, and elevated system costs. To eliminate circulating current, the proposed control strategy constrains the ratio between 1-D₁ and 1-D₃, denoted as a, based on the primary-side and secondary-side voltages as well as the transformer turns ratio. A normalized transmitted power Y is then calculated, and the optimal set of phase-shift ratios D₁, D₂ and D₃ is selected to minimize both switching and conduction losses under non-circulating-current power transfer, thereby enabling high-efficiency operation. The method further ensures zero-voltage turn-on for all switches and zero-current turn-off for half of the switches, significantly reducing switching losses.

### CROSS-REFERENCE TO RELATED APPLICATION

This application claims priority to Chinese Patent Application No. 202510141430.3, filed on Feb. 8, 2025 before the China National Intellectual Property Administration, the disclosure of which is incorporated herein by reference in entirety.

### TECHNICAL FIELD

The present invention relates to the technical field of converter control, and in particular to a non-circulating-current phase-shift control method and system for a DAB converter.

### BACKGROUND

With the development of renewable energy, electric vehicles and energy storage industries, the demand for efficient DC/DC converters that safely and reliably support bidirectional energy transmission in critical applications has increased. Dual-Active-Bridge (DAB) DC/DC converters have attracted widespread attention due to their advantages such as bidirectional energy transmission, electrical isolation, soft switching, high energy conversion efficiency, and high-power density.

However, a significant limitation of DAB converters arises when the voltages between the primary and secondary sides are mismatched, resulting in substantial circulating power. This circulating power significantly increases current stress and root mean square (RMS) current, thereby increasing the cost of power devices, converter losses, and cooling requirements. Furthermore, it necessitates greater design complexity in protection circuitry and thermal management systems, ultimately compromising the overall cost-effectiveness, reliability, and performance of the converter system.

### SUMMARY

To eliminate the circulating power in a dual active bridge converter, the present invention proposes a non-circulating-current phase-shift control method. This method enables high-efficiency and stable operation of the DAB converter under a non-circulating current condition.

A typical DAB converter consists of a high-frequency transformer, an inductor, and two active bridges, with each active bridge positioned on the primary and secondary sides of the transformer, respectively. The transformer provides galvanic isolation between the primary and secondary circuits via magnetic coupling and allows for flexible voltage conversion through transformer turns ratio adjustment. The inductor, commonly placed on one side of the transformer or realized by the transformer's leakage inductance, facilitates energy transfer while reducing system cost and volume.

Phase-shift control is commonly used in DAB converters. As the DAB comprises two active bridges, up to three independent phase-shift ratios can be introduced. Specifically, the intra-bridge phase-shift ratios on the primary and secondary sides are defined as D₁ and D₃, respectively, while the inter-bridge phase-shift ratio is defined as D₂. The domains of D₁ and D₃ are [0, 1], and the domain of D₂ is [−1, 1]. Different combinations of these three phase-shift ratios correspond to different operating modes and transferred power levels. To suppress circulating current during operation, the converter must operate within a specific domain-defined in this invention as the feasible region X_{f} for the proposed algorithm.

Within the feasible region X_{f}, the proposed non-circulating-current phase-shift control method limits the ratio between 1-D₁ and 1-D₃, denoted as a, based on the primary and secondary voltages as well as the transformer turns ratio. This constraint effectively eliminates the circulating current. A normalized transmitted power, denoted as Y, can be determined from either the output current or the desired transmitted power. Within the feasible region X_{f}, all combinations of phase-shift ratios that satisfy both a and Y can be identified, each enabling operation of the dual-active-bridge (DAB) converter without circulating current. By modeling both switching losses and conduction losses, it is determined that among these combinations, the one with the minimum values of phase-shift ratios D₁ and D₃ yields the highest efficiency, and is therefore selected as the optimal solution of the proposed non-circulating-current phase-shift control method. Meanwhile, the proposed control method ensures zero-voltage turn-on for all switches and zero-current turn-off for half of the switches, thereby significantly reducing switching losses. The resulting phase-shift ratios are then used to control the switching behavior of the DAB converter to deliver the required power.

### BRIEF DESCRIPTION OF THE DRAWINGS

FIG. 1 is a schematic diagram of a DAB converter provided in one embodiment;

FIG. 2 shows the definition of the three phase-shift ratios and the corresponding switching control waveforms provided in one embodiment;

FIG. 3 shows the range of normalized power transmission under the non-circulating-current phase-shift control method with different voltage ratios;

FIG. 4 is a typical waveform diagram of a non-circulating-current phase-shift control method for a DAB converter under forward power flow operation provided in one embodiment;

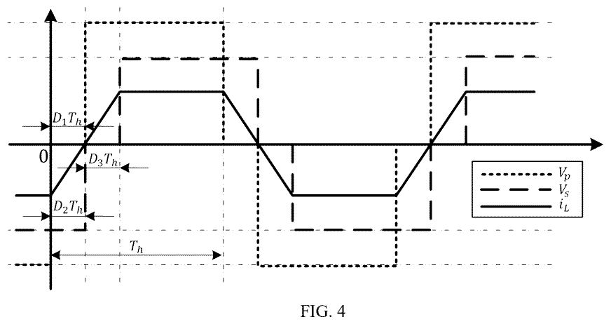

FIG. 5 is a typical waveform diagram of a non-circulating-current phase-shift control method for a DAB converter under reverse power flow operation provided in one embodiment;

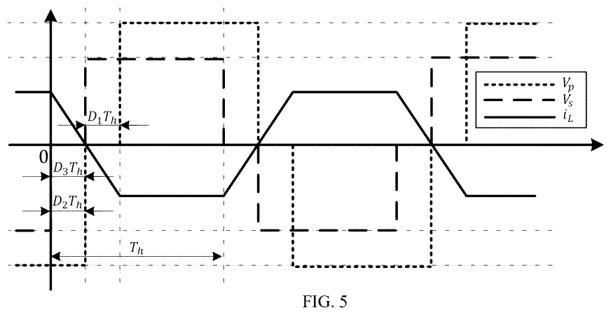

FIG. 6 is a schematic diagram illustrating the calculation procedure performed by the controller in a non-circulating-current phase-shift control method for a DAB converter, according to one embodiment.

### DETAILED DESCRIPTION OF EMBODIMENTS

In order to make the purpose, technical solution and advantages of the present invention more clearly understood, the present invention is further described in detail below in conjunction with the accompanying drawings and embodiments. It should be understood that the specific embodiments described herein are only used to explain the present invention and are not used to limit the present invention.

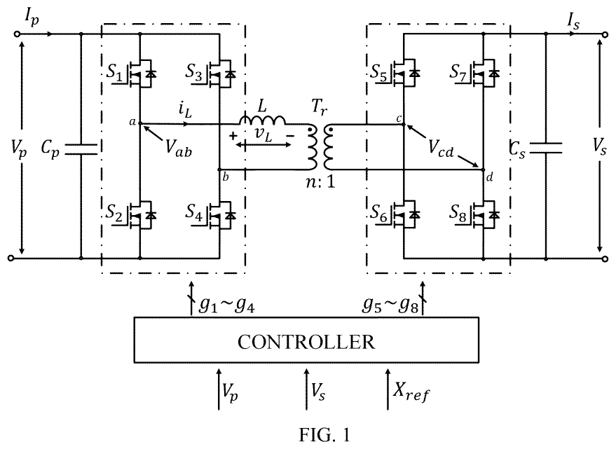

In one embodiment, a DAB converter is provided, and FIG. 1 shows a schematic diagram of the DAB converter. The schematic diagram includes a DAB topology and a controller. The DAB topology includes an inductor L, a high-frequency transformer Tᵣ, and two active full-bridge circuits coupled by the inductor L and the high-frequency transformer Tᵣ. The inductor L can also be implemented using the leakage inductance of the transformer. n represents the turns ratio of the transformer between the primary side and the secondary side. Each active full-bridge consists of four switches. The switches in the primary-side bridge are denoted as S₁, S₂, S₃, and S₄, while those in the secondary-side bridge are denoted as S₅, S₆, S₇, and S₈. The switches may be implemented using various semiconductor devices, such as Si MOSFETs, SiC MOSFETs, GaN HEMTs, or IGBTs. DC-link filter capacitors C_{P} and Cₛ are connected in parallel with the active bridges on the primary and secondary sides, respectively, and function to filter and stabilize the voltages on both sides of the DAB converter. V_{P} and Vₛ denote the primary and secondary side voltages of the converter, respectively. I_{P} and Iₛ denote the primary and secondary side currents of the converter, respectively. Both ports of the DAB converter may be connected to batteries, in which case the converter is capable of bidirectional power transfer. Alternatively, one or both batteries may be replaced with a power source or a passive load, in which case the converter operates in a unidirectional power transfer mode. For the sake of clarity, power transferred from the primary side to the secondary side is defined as forward power transfer, while the reverse direction is defined as reverse power transfer.

The controller illustrated in FIG. 1 can be implemented using a Microcontroller Unit (MCU), a Digital Signal Processor (DSP), or a Field-Programmable Gate Array (FPGA). The controller first samples the primary-side voltage V_{P} and the secondary-side voltage Vₛ. Then, based on these sampled voltages, a reference value X_{ref} for power transfer, and circuit parameters, the controller calculates three phase-shift ratios. These phase shift ratios are subsequently used to generate drive signals gₓ(x=1˜8) that control the switching actions of the eight switches in the DAB converter.

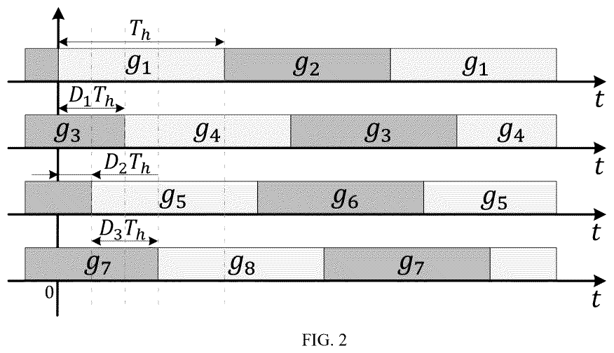

FIG. 2 shows the definition of the three phase-shift ratios and the corresponding switching control waveforms provided in one embodiment. The driving signal gₓ(x=1˜8) of all switches of the DAB converter is a square wave signal with a duty cycle of 50%, and the signals of the upper bridge arm and the lower bridge arm are complementary. Wherein Tₕ represents half a switching cycle, and its magnitude is equal to 0.5/fₛ,fₛ denotes the switching frequency of the DAB converter. The definition domains of D₁ and D₃ are [0, 1], where D₁Tₕ denotes the time delay of signal g₄ with respect to g₁, and D₃Tₕ denotes the time delay of signal g₈ with respect to g₅. The definition domain of D₂ is [−1, 1]. When D₂>0, D₂Tₕ represents the delay of signal g₅ with respect to g₁; when D₂<0, D₂Tₕ represents the advance of signal g₅ relative to g₁.

In one embodiment, a non-circulating-current phase-shift control method for a DAB converter is provided, the method comprising:

Obtain the steady-state primary-side voltage V_{P} and the steady-state secondary-side voltage Vₛ. Calculate the voltage ratio α across the inductor based on the steady-state values of V_{P} and Vₛ, as well as the transformer turns ratio n. The voltage ratio α is defined as:

$$α = \frac{{nV}_{s}}{{V}_{p}} = \frac{1 - {D}_{1}}{1 - {D}_{3}} . \qquad ( 1 )$$

If both ports of the DAB converter are connected to power sources or batteries, the steady-state voltages V_{P} and Vₛ are equal to the corresponding sampled voltages. If one port of the DAB converter is connected to a passive load, the corresponding steady-state voltage V_{P} or Vₛ shall be equal to its control target value.

The transmitted power of the DAB converter can be expressed as

$$P = \frac{{nV}_{p} {V}_{s}}{4 {f}_{s} L} Y . \qquad ( 2 )$$

When the converter operates in constant power mode, the normalized transmitted power Y can be calculated as

$$Y = \frac{4 {f}_{s} L}{n {V}_{p} {V}_{s}} P . \qquad ( 3 )$$

where a value of Y<0 indicates reverse power transfer. If constant current control or constant voltage control is employed, the target current or voltage may be converted to an equivalent constant transmitted power based on Ohm's law, thereby enabling calculation of the normalized transmitted power Y. If the output port of the converter is connected to a passive load and operates under constant voltage control, a PI controller may be used to calculate the normalized transmitted power Y based on the voltage deviation.

In order to completely eliminate the circulating power of the DAB converter, the phase-shift ratios must satisfy the constraint

$$\{ \begin{matrix}0 \leq {D}_{2} \leq {D}_{1} \leq {D}_{2} + {D}_{3} \leq 1 , Y \geq 0 \\ 0 \leq - {D}_{2} \leq {D}_{3} \leq {D}_{1} - {D}_{2} \leq 1 , Y < 0\end{matrix} \qquad ( 4 )$$

during both forward and reverse power transfer modes. When the voltages at the two ports of the converter are different, the maximum transferable power also varies. Accordingly, under different voltage ratios α, the range of the normalized transmitted power Y can be expressed as

$$\vert Y \vert \leq \frac{α}{{α}^{2} + α + 1} . \qquad ( 5 )$$

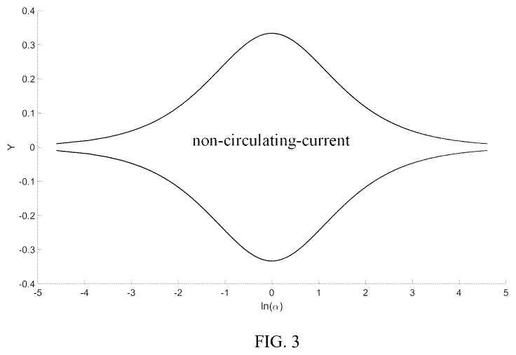

FIG. 3 illustrates the range of the normalized transmitted power under various voltage ratios. To better visualize this range, the horizontal axis is presented in the form of the natural logarithm of the voltage ratio α. As shown in the figure, circulating power occurs when the transmitted power exceeds the boundary. Moreover, as the voltage mismatch increases, the range of power that can be transmitted without circulating current becomes narrower.

Through modeling and optimization of the switching losses and conduction losses of the DAB converter, it is determined that, under the same voltage ratio and normalized transmitted power, the efficiency of the DAB converter increases as the phase-shift ratios D₁ and D₃ decrease. Therefore, after calculating the voltage ratio and normalized transmitted power, the phase-shift ratios D₁, D₂ and D₃ can be determined using the formulas provided in Table I, so as to achieve maximum efficiency operation. The controller then generates the gate drive signals gₓ(x=1˜8) based on the calculated phase-shift ratios, thereby enabling power transfer through the DAB converter.

TABLE I
$α ∈ ( 0 , + ∞ ) , \vert Y \vert \leq \frac{α}{{α}^{2} + α + 1}$

| α > 1 | α = 1 | α < 1 | | |
|---|---|---|---|---|
| $\vert Y \vert < \frac{α - 1}{{α}^{2}}$ | $\vert Y \vert \geq \frac{α - 1}{{α}^{2}}$ | — | \|Y\| ≥ α-α² | \|Y\| < α-α² |

| | | |
|---|---|---|
| ${D}_{3} = 1 - \sqrt{\frac{\vert Y \vert}{α - 1}}$ | ${D}_{3} = \frac{{α}^{2} - \sqrt{α - \vert Y \vert ( {α}^{2} + α + 1 )}}{{α}^{2} + α + 1}$ | ${D}_{3} = 1 - \sqrt{\frac{\vert Y \vert}{α - {α}^{2}}}$ |

D₁ = 1-α(1-D₃)
$\{ \begin{matrix}{D}_{2} = 1 - {D}_{3} - \sqrt{( 1 - {D}_{1} ) ( 1 - {D}_{3} ) - \vert Y \vert} , Y \geq 0 \\ {D}_{2} = - ( 1 - {D}_{1} ) + \sqrt{( 1 - {D}_{1} ) ( 1 - {D}_{3} ) - \vert Y \vert} , Y < 0\end{matrix}$

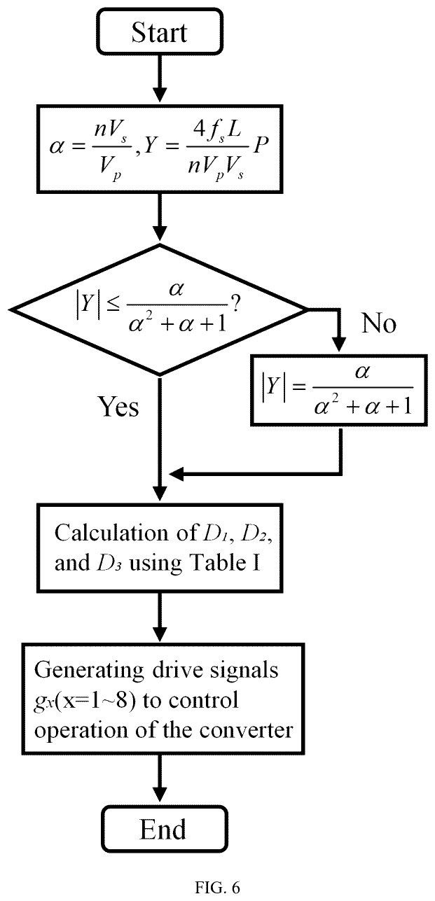

FIG. 6 shows a schematic diagram illustrating the calculation procedure performed by the controller in a non-circulating-current phase-shift control method for a DAB converter, according to one embodiment.

First, the controller acquires the primary-side and secondary-side voltages, as well as the transmitted power, to calculate the voltage ratio α and the normalized transmitted power Y. It then determines whether the absolute value of Y falls within the non-circulating-current power transmission region, as shown in FIG. 3. If the absolute value of Y exceeds the maximum boundary of the non-circulating-current power region, |Y| is set equal to this maximum boundary. This process is intended to limit overshoot during startup and to prevent the normalized transmitted power Y from exceeding the maximum transferable power. During steady-state operation, the normalized transmitted power Y must remain within the non-circulating-current transmission boundary. After obtaining the voltage ratio α and the absolute value of the normalized transmitted power |Y|, the phase-shift ratios D₁, D₂ and D₃, are calculated using the formulas provided in Table I. The controller then generates eight gate drive signals gₓ(x=1˜8) to control power transfer through the DAB converter.

The above-mentioned embodiments only express several implementation methods of the present invention, and the description is relatively specific and detailed, but it cannot be understood as limiting the scope of the invention patent. It should be pointed out that for ordinary technicians in this field, several modifications and improvements can be made without departing from the concept of the present invention, which all belong to the protection scope of the present invention.

What is claimed is:

1. A non-circulating-current phase-shift control method for a DAB converter, wherein the DAB converter comprises an inductor L, a high-frequency transformer Tᵣ, and two active full-bridge circuits coupled through the inductor L and the high-frequency transformer Tᵣ, wherein each of the active full-bridge circuits comprises four switches; wherein the method comprises:
Obtaining the steady-state primary-side voltage V_{P} and the steady-state secondary-side voltage Vₛ;
Calculating the voltage ratio α across the inductor based on the steady-state values of V_{P} and Vₛ, as well as the transformer turns ratio n;
Calculating a normalized transmitted power Y based on a required transmitted power and circuit parameters, or determining the normalized transmitted power Y using a PI controller;
Calculating the phase-shift ratios D₁, D₂ and D₃ based on the voltage ratio α and normalized transmitted power Y;
Generating drive signals gₓ(x=1˜8) based on the calculated phase-shift ratios D₁, D₂ and D₃ to control power transfer through the dual-active-bridge converter.

2. The non-circulating-current phase-shift control method for a DAB converter according to claim 1, characterized in that:
in the DAB converter, the inductor L can also be implemented using the leakage inductance of the transformer Tᵣ;
wherein, the switches may be implemented using various semiconductor devices, such as Si MOSFETs, SiC MOSFETs, GaN HEMTs, or IGBTs;
wherein, n represents the turns ratio of the transformer between the primary side and the secondary side.

3. The non-circulating-current phase-shift control method of a DAB converter according to claim 1, wherein the obtaining of the steady-state primary-side voltage V_{P} and the steady-state secondary-side voltage Vₛ comprises:
setting the steady-state voltages V_{P} and Vₛ equal to the corresponding sampled voltages when both ports of the DAB converter are connected to power sources or batteries; and
setting the corresponding steady-state voltage V_{P} and Vₛ equal to a control target value when one port of the DAB converter is connected to a passive load.

4. The non-circulating-current phase-shift control method of a DAB converter according to claim 1, wherein calculating a voltage ratio α across an inductor comprises defining the voltage ratio α as:
$$α = \frac{{nV}_{s}}{{V}_{p}} .$$

5. The non-circulating-current phase-shift control method of a DAB converter according to claim 1, wherein calculating a normalized transmitted power Y based on a required transmitted power and circuit parameters, or determining the normalized transmitted power Y using a PI controller comprises:
calculating the normalized transmitted power Y according to Equation:
$$Y = \frac{4 {f}_{s} L}{{nV}_{p} {V}_{s}} P ,$$
wherein a value of Y<0 indicates reverse power transfer, when the converter operates in constant power mode;
converting a target current or voltage into an equivalent constant transmitted power using Ohm's law when constant current control or constant voltage control is employed, to enable calculation of the normalized transmitted power Y; and
using a PI controller to calculate the normalized transmitted power Y based on a voltage deviation when the output port of the converter is connected to a passive load and operates under constant voltage control.

6. The non-circulating-current phase-shift control method of a DAB converter according to claim 1, wherein calculating the phase-shift ratios D₁, D₂ and D₃ based on the voltage ratio α and the normalized transmitted power Y comprises:
constraining the normalized transmitted power Y to be within a boundary defined by a maximum non-circulating-current transmitted power; and
calculating the phase-shift ratios D₁, D₂ and D₃ using a formula provided in Table I based on the voltage ratio α and the normalized transmitted power Y.

7. The non-circulating-current phase-shift control method of a DAB converter according to claim 6, wherein the phase-shift ratios D₁, D₂ and D₃ are constrained as follows:
the definition domains of D₁ and D₃ are [0, 1];
the definition domain of D₂ is [−1, 1]; and
to completely eliminate the circulating power of the DAB converter, the phase-shift ratios must satisfy the constraint:
$$\{ \begin{matrix}0 \leq {D}_{2} \leq {D}_{1} \leq {D}_{2} + {D}_{3} \leq 1 , Y \geq 0 \\ 0 \leq - {D}_{2} \leq {D}_{3} \leq {D}_{1} - {D}_{2} \leq 1 , Y < 0\end{matrix}$$

8. The non-circulating-current phase-shift control method of a DAB converter according to claim 6, wherein the voltage ratio α and the phase-shift ratios D₁ and D₃ are constrained by the following relationship:
$$α = \frac{1 - {D}_{1}}{1 - {D}_{3}} .$$

9. The non-circulating-current phase-shift control method of a DAB converter according to claim 6, wherein constraining the normalized transmitted power Y to be within a boundary defined by a maximum non-circulating-current transmitted power, the boundary being determined by the following relationship:
$$\vert Y \vert \leq \frac{α}{{α}^{2} + α + 1} .$$

10. The non-circulating-current phase-shift control method of a DAB converter according to claim 6, wherein calculating the phase-shift ratios D₁, D₂ and D₃ using a formula provided in Table I based on the voltage ratio α and the normalized transmitted power Y comprises:
selecting a combination of phase-shift ratios D₁, D₂ and D₃ that satisfies the given a and Y, and in which D₁ and D₃ are minimized.

11. The non-circulating-current phase-shift control method of a DAB converter according to claim 1, wherein generating drive signals gₓ(x=1˜8) based on the calculated phase-shift ratios D₁, D₂ and D₃ to control power transfer through the dual-active-bridge converter comprises:
setting each drive signal gₓ(x=1˜8) as a square wave signal with a duty cycle of 50%, wherein the signals for the upper and lower bridge arms are complementary;
setting a delay of D₁Tₕ for signal g₄ with respect to signal g₁, and a delay of D₃Tₕ for signal g₈ with respect to signal g₅;
when D₂>0, setting a delay of D₂Tₕ for signal g₅ with respect to signal g₁; and when D₂<0, setting an advance of D₂Tₕ for signal g₅ with respect to signal g₁;
Wherein Tₕ represents half a switching cycle, and its magnitude is equal to 0.5/fₛ, fₛ denotes the switching frequency of the DAB converter.
